(19) United States
(12) Patent Application Publication
(10) Pub. No.: US 2019/0137386 A1
(43) Pub. Date: May 9, 2019

(54) GAS OBSERVATION METHOD

(71) Applicant: KONICA MINOLTA, INC., Chiyoda-ku, Tokyo (JP)

(72) Inventors: Takashi MORIMOTO, Suita-shi, Osaka (JP); Shunichi HAYAMIZU, Amagasaki-shi, Hyogo (JP); Yasushi IIJIMA, Katsushika-ku, Tokyo (JP)

(73) Assignee: KONICA MINOLTA, INC., Chiyoda-ku, Tokyo (JP)

(21) Appl. No.: 16/095,285

(22) PCT Filed: Apr. 13, 2017
(86) PCT No.: PCT/JP2017/015179

§ 371 Date: Oct. 19, 2018

(30) Foreign Application Priority Data
Apr. 20, 2016 (JP) 2016-084466

(51) Int. Cl. G01N 21/3504; G01K 13/02

(52) U.S. Cl. CPC G01N 21/3504; G01K 2013/024; G01K 13/02

(57) ABSTRACT

In an observation method for detecting presence of a target gas, first luminance information is obtained from a background, and second luminance information is obtained from luminance radiated from the background and observed through gas to be observed. An optical member capable of transmitting electromagnetic waves in a specific wavelength band and having the same temperature as atmospheric temperature is arranged between the background and an imaging device. Luminance information for an optical image obtained without passing through the optical member and luminance information for an optical image obtained through the optical member are used and an optical image corresponding to atmospheric temperature for the observation space or the vicinity thereof and comprising blackbody radiation electromagnetic waves in a specific wavelength band is obtained as third luminance information. The first to third luminance information is used and spatial distribution information for a concentration-thickness product for the gas is obtained.

### CROSS-REFERENCE TO RELATED APPLICATIONS

The present U.S. patent application is a U.S. National Phase application under 35 U.S.C. 371 of International Application PCT/JP2017/015179, filed Apr. 13, 2017, which is based on and claims priority under the Paris Convention of Japanese Patent Application No. 2016-084466, filed Apr. 20, 2016, the entirety of which is incorporated herein by reference.

### TECHNICAL FIELD

The present invention relates to a gas observation method. More particularly, the present invention relates to a gas observation method for detecting gas through an image acquired by an infrared imaging device.

### BACKGROUND ART

In recent years, in gas consumption places such as petrochemical plants, gasworks, and power stations, there has been an increasing risk of gas leakage incidents occurring due to deterioration of equipment. Thus, in such factories and the like, for the purpose of detecting gas leakage and dealing with it promptly, a large number of gas detectors are installed mainly at places where gas leakage is more likely to occur. However, the gas detectors are configured to issue an alarm when their sensor parts make contact with gas, and thus cannot detect gas present in a space between themselves.

On the other hand, methods using an infrared imaging device as another method for detecting the presence of gas are proposed in Patent Documents 1 and 2 and non-Patent Document 1. These methods use optical radiation from the background mainly in the infrared region (what is called black-body radiation radiated from all kinds of objects) and the optical absorption characteristics of gas in the infrared region. That is, the presence of gas is detected by relying on the fact that the amount of infrared rays from the background changes with the presence of gas. With these methods, it is possible to detect as an image the two-dimensional spatial distribution of the region where gas is present; this makes it possible to detect gas without requiring a large number of detecting devices, and to find the source of leakage by a method such as by image analysis.

### LIST OF CITATIONS

### Patent Literature

Patent Document 1: WO 2008/135654
Patent Document 2: EP-0544962

### Non-Patent Literature

Non-Patent Document 1: Harig, R., Matz, G., Rusch, P., Gerhard, J.-H., Schafer, K., Jahn, C., Schwengler, P., Beil, A.: “Remote Detection of Methane by Infrared Spectrometry for Airborne Pipeline Surveillance: First Results of Ground-Based Measurements”, SPIE 5235, 435-446, 2004.

### SUMMARY OF THE INVENTION

### Technical Problem

The information acquired by the above-described methods using an infrared imaging device is the product of the density of gas by the depth (thickness) of a gas region in the direction of the line of sight of the imaging device, that is, the spatial distribution of the density-by-depth product. Thus, the spatial distribution of the density-by-depth product is detected from the infrared variation, and to be noted here is that the infrared variation is characterized by depending also on the gas temperature as disclosed in non-Patent Document 1. Thus, to detect the spatial distribution of the density-by-depth product, information on the gas temperature is necessary.

To calculate the density-by-depth product with consideration given also to the information on the gas temperature in addition to the infrared variation, it is necessary to acquire the amount of infrared rays as gas temperature information. Specifically, it is necessary to acquire, with the infrared imaging device, as gas temperature information the intensity of electromagnetic waves in the form of luminance data. That is, it is necessary to convert ambient temperature data into luminance data. Generally, the ambient temperature is measured by use of a thermometer, and to convert measured ambient temperature data into luminance data, a conversion formula is used.

However, thermometers generally have errors, and vary by about 0.1° C. to 0.5° C. among them. Also infrared imaging devices used have different characteristics, and thus errors occur in the conversion step using a formula for converting ambient temperature data into luminance data. Thus, with the conventional technology, it is impossible to accurately convert ambient temperature data into luminance data. Moreover, when a thermometer is arranged, so as to accurately measure the gas temperature, close to a place where a risk of gas leakage is predicted, the more there are places at which to arrange one, the more cables for transmitting ambient temperature data and power cables are required; this results in an increase not only in installation cost but also in maintenance cost for coping with deterioration of and damage to devices.

Patent Document 2 proposes a method for measuring the density-by depth product without measurement of the ambient temperature; this method, however, can be applied only when gas having the same density-by-depth product is present in front of the background having two different infrared luminances. The distribution of the density-by-depth product of gas is generally not even; thus, this method is not applicable in a wide range within the field of view of the imaging device, and is applicable only near the boundary lines of the background having two different infrared luminances. Thus, it is difficult to accurately calculate the spatial distribution of the density-by-depth product of gas.

Against the background discussed above, an object of the present invention is to provide a gas observation method that permits high accuracy acquisition of spatial distribution information on the density-by depth product of observation target gas.

### Means for Solving the Problem

To achieve the above-mentioned object, according to an aspect of the present invention, a gas observation method reflecting one aspect of the present invention, is a gas observation method for detecting the presence of observation target gas in an observation target space by acquiring luminance information on the observation target gas and the background thereof with an imaging device that has sensitivity to electromagnetic waves in a particular wavelength band out of electromagnetic waves radiated or reflected from the surface of an object and that acquires as the luminance information an optical image comprising electromagnetic waves in the particular wavelength band includes: acquiring as first luminance information an optical image comprising electromagnetic waves in the particular wavelength band radiated from the background; acquiring as second luminance information an optical image comprising electromagnetic waves in the particular wavelength band radiated from the background and observed through the observation target gas; acquiring, with an optical member arranged between the background the imaging device, the optical member being able to transmit electromagnetic waves in the particular wavelength band and having a temperature equal to the ambient temperature, by use of luminance information on the optical image acquired without passage through the optical member and luminance information on the optical image acquired through the optical member, as third luminance information an optical image corresponding to the ambient temperature in or around the observation target space and comprising black-body radiation electromagnetic waves in the particular wavelength band; and acquiring spatial distribution information on the density-by-depth product of the observation target gas by use of the first to third luminance information.

### Advantageous Effects of the Invention

According to the present invention, without use of thermometers, no errors occur in ambient temperature information resulting from variations among thermometers or errors in a data conversion step. Thus, it is possible to acquire ambient temperature data as luminance data with high accuracy, and thus to acquire spatial distribution information on the density-by-depth product of observation target gas with high accuracy.

### BRIEF DESCRIPTION OF DRAWINGS

The advantages and features provided by one or more embodiments of the invention can be fully understood from the detailed description given hereinbelow and the appended drawings which are given by way of illustration only, and thus are not intended as a definition of the limits of the present invention:

FIG. 1 is a flow chart showing an observation procedure example 1 of a gas observation method according to an embodiment;

FIG. 2 is a flow chart showing an observation procedure example 2 of a gas observation method according to an embodiment;

FIG. 3 is a flow chart showing an observation procedure example 3 of a gas observation method according to an embodiment;

FIG. 4 is a flow chart showing an observation procedure example 4 of a gas observation method according to an embodiment;

FIG. 5 is a flow chart showing an observation procedure example 5 of a gas observation method according to an embodiment;

FIG. 6 is a diagram showing an outline of a configuration example of an imaging device for implementing a gas observation method according to an embodiment;

FIG. 7 is a diagram illustrating image changes over frames with respect to a specific example 1 of step 1 of a gas observation method according to an embodiment;

FIG. 8 is a flow chart showing control operation with respect to a specific example 1 of step 1 of a gas observation method according to an embodiment;

FIG. 9 is a diagram illustrating luminance changes from one frame to another with respect to a specific example 2 of step 1 of a gas observation method according to an embodiment;

FIG. 10 is a schematic sectional view of an optical filter and an imaging device used in a specific example 3 of step 1 of a gas observation method according to an embodiment;

FIG. 11 is a plan view showing, in a state as seen from the imaging device side, an optical member used in a specific example 1 of step 3 of a gas observation method according to an embodiment and a background along with luminance measurement points on them;

FIG. 12 is a plan view showing, in a state as seen from the imaging device side, an optical member used in a specific example 2 of step 3 of a gas observation method according to an embodiment and a background along with luminance measurement points on them;

FIG. 13 is a diagram showing, on a shot image screen, an arrangement example 1 of the optical member used at step 3 of a gas observation method according to an embodiment;

FIG. 14 is a diagram showing, on a shot image screen, an arrangement example 2 of the optical member used at step 3 of a gas observation method according to an embodiment; and

FIG. 15 is a diagram showing, on a shot image screen, an arrangement example 3 of the optical member used at step 3 of a gas observation method according to an embodiment.

### DESCRIPTION OF EMBODIMENTS

Hereinafter, one or more embodiments of the present invention will be described with reference to the drawings. However, the scope of the invention is not limited to the disclosed embodiments. And such parts as are identical or equivalent among different embodiments are identified by common reference signs, and overlapping description will be omitted unless necessary.

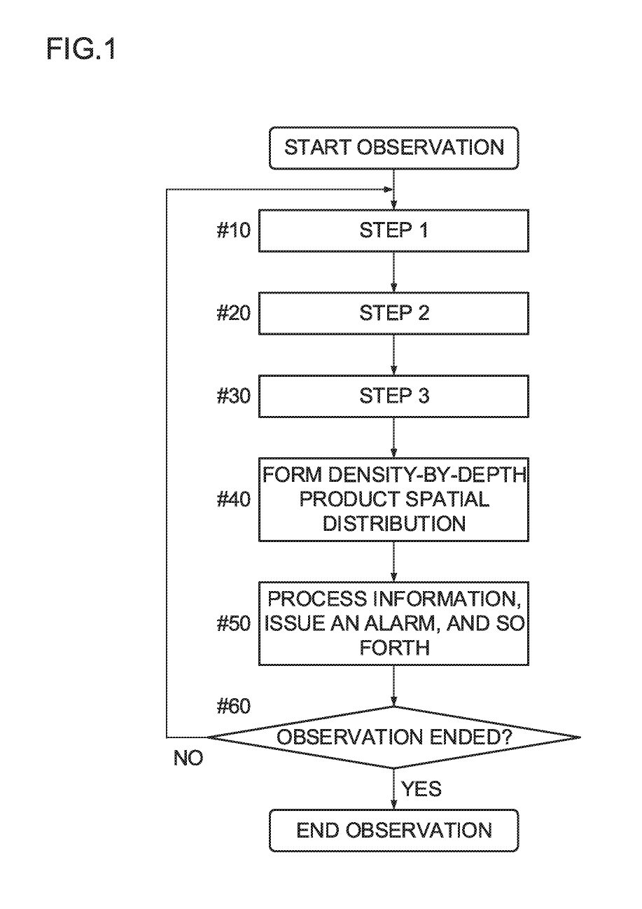

FIGS. 1 to 5 are flow charts showing observation procedure examples 1 to 5, respectively, of a gas observation method according to an embodiment. The observation procedure examples 1 to 5 each include three steps 1 to 3 (#10 to #30), a step (#40) for forming a spatial distribution image of the density-by-depth product of observation target gas (the product of the density of gas by the depth (thickness) of a gas region in the observation direction), and a step (#50) for processing information, giving off an alarm, etc., and ends the observation on judging that the observation is complete (#60). In these gas observation methods, luminance information on observation target gas and its background is acquired with an imaging device, and thereby the presence of the observation target gas in an observation target space is detected. That is, an observation target space is shot with an imaging device, and thereby spatial distribution information on the density-by-depth product of the gas present in the observation target space is acquired.

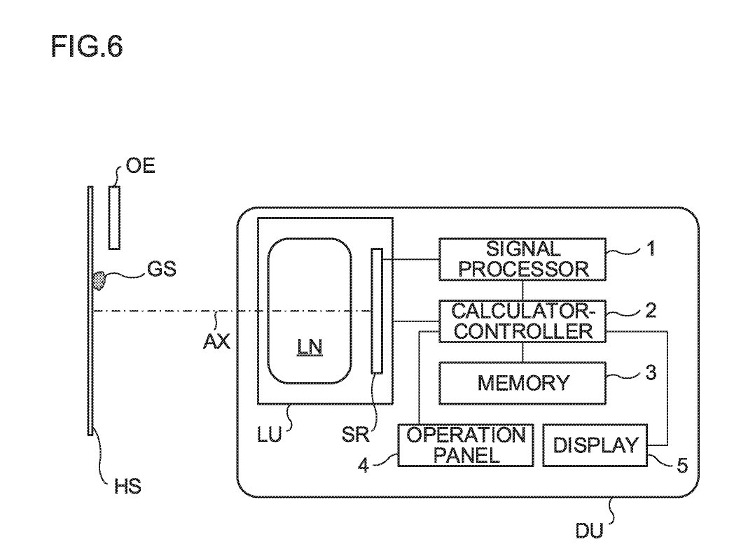

FIG. 6 shows an outline of a configuration example of an imaging device DU used in a gas observation method according to an embodiment. This imaging device DU has sensitivity to electromagnetic waves in a particular wavelength band out of electromagnetic waves radiated or reflected from the surface of an object of which the absolute temperature is equal to or higher than zero degrees, and serves to acquire, as luminance information, an optical image comprising the electromagnetic waves in the particular wavelength band. A representative example of the electromagnetic waves in the specific wavelength band is infrared light, and a specific example of the imaging device DU is an infrared imaging device (that is, an infrared camera having sensitivity in the infrared wavelength region).

A more specific example of the imaging device DU is an infrared imaging device that can detect at least part of wavelengths in a wavelength band of 1 to 16 μm, such as an uncooled far-infrared imaging device that detects wavelengths of 8 to 16 μm or a cooled mid-infrared imaging device that detects wavelengths of 3 to 5 μm. That is, the particular wavelength region can be set according to the absorption characteristics of observation target gas to be subjected to leakage detection, and accordingly an imaging device DU having detection sensitivity in the particular wavelength region can be selected. For example, when a hydrocarbon gas is the observation target gas GS, the light-absorption band of the gas present in a wavelength band of 3 to 4 μm is used, and thus an imaging device DU having sensitivity in that wavelength band is selected.

When gas leakage occurs, the observation target gas GS appears in an observation target space located in front of the imaging device DU. Between a background HS and the imaging device DU, at a place near the observation target space within the field of view of the imaging device DU, an optical member OE for measuring ambient temperature is arranged. This optical member OE has the same temperature as the ambient temperature, can transmit electromagnetic waves in the particular wavelength band (that is, the optical member OE has such optical characteristics that the transmittance to electromagnetic waves in the particular wavelength band is higher than 0% but lower than 100%), and is used to acquire luminance information, which corresponds to the ambient temperature in or around the observation target space (#30; step 3 at which third luminance information is acquired).

An example of the optical member OE is an electromagnetic-wave absorbing material such as a glass plate or a plastic plate. The transmittance of the optical member OE with respect to electromagnetic waves in the particular wavelength band only has to be higher than 0% but lower than 100%, and preferably, the transmittance of the optical member OE with respect to the electromagnetic waves is, for example, 50%. That is, as the optical member OE, a translucent plate is preferably used which has a transmittance (for example, an infrared transmittance) of 50% to electromagnetic waves in the particular wavelength band. To reduce reflection on the surface of the optical member OE, it is also preferable to provide the surface with irregularities smaller than the observation wavelength or to apply anti-reflective coating to the surface.

The imaging device DU includes, for taking still and moving images of an object surface, a lens unit LU which optically takes in an optical image and outputs it as an electrical signal. The lens unit LU includes, in order from the object side (that is, the subject side), an image lens LN (AX: optical axis) which forms an optical image of the object (that is, a subject image), and an image sensor SR which converts the optical image formed by the image lens LN into an electrical signal.

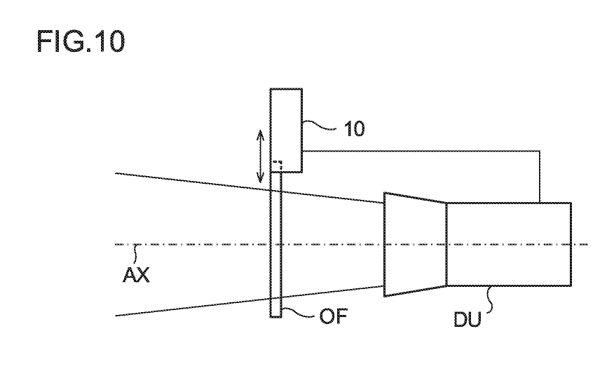

The imaging device DU includes, in addition to the lens unit LU, a signal processor 1, a calculator-controller 2, a memory 3, an operation panel 4, a display 5, etc. The signal generated by the image sensor SR is subjected to predetermined digital image processing, image compression processing, etc. as necessary in the signal processor 1, and is recorded as a digital video signal in the memory 3 (such as a semiconductor memory or an optical disk) or, in some cases, transferred to an external device by a communication function via a cable or after being converted into an infrared signal or the like. The calculator-controller 2 comprises a micro-computer, and performs, in a concentrated fashion, control of functions such as a luminance information processing function, an image taking function, and an image playback function and control of movement mechanisms of the image lens LN, an optical filter OF (FIG. 10), etc., and so forth. The display 5 is a portion which includes a display such as a liquid crystal monitor, and displays an image by use of an image signal converted by the image sensor SR or recorded image information. The operation panel 4 is a portion which includes operation members such as operation buttons, and transmits to the calculator-controller 2 information entered through operation by an operator.

In the observation procedure example 1 (FIG. 1), first, at step 1 (#10), the electromagnetic-wave luminance of the background HS in the observation target space is shot with the imaging device DU, and thereby two-dimensional luminance information is acquired. That is, an optical image comprising the electromagnetic waves in the particular wavelength band radiated from the background HS is acquired as first luminance information. At step 2 (#20), through the observation target gas GS present in the observation target space, the electromagnetic-wave luminance of the background HS is shot with the imaging device DU, and thereby two-dimensional luminance information is acquired. That is, an optical image comprising the electromagnetic waves in the particular wavelength band observed through the observation target gas GS radiated from the background HS is acquired as second luminance information. At step 3 (#30), the ambient temperature-equivalent black-body radiance electromagnetic-wave luminance is acquired by the imaging device DU. That is, an optical image that corresponds to the ambient temperature in or around the observation target space in which the observation target gas GS is present and that comprises black-body radiation electromagnetic waves in the particular wavelength band is acquired as third luminance information.

It is not essential to perform steps 1 to 3 (#10 to #30) in the above-described observation procedure example 1 in this order; instead, these steps may be performed simultaneously. After steps 1 to 3, by use of the above-described first to third luminance information, spatial distribution information on the density-by-depth product of the observation target gas GS is acquired (#40); information is processed, an alarm is given off, and so forth (#50); and the observation ends if it is judged that the observation is complete (#60). An example of the spatial distribution information on the density-by-depth product of the observation target gas GS is a spatial distribution image comprising density gradations or the like, and if it is judged, through the processing of the formed spatial distribution image or the like, that gas leakage is occurring, an alarm or the like is issued.

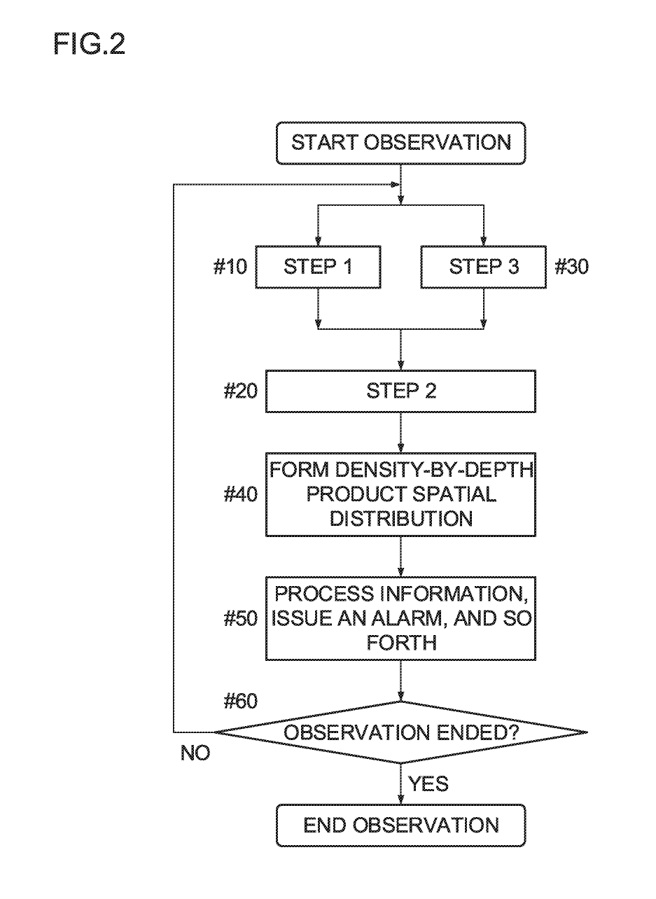

In the observation procedure example 2 (FIG. 2), except that step 1 (#10) and step 3 (#30) are performed simultaneously, the same procedure as in the observation procedure example 1 (FIG. 1) is performed. While, in the observation procedure example 2, step 2 is performed after steps 1 and 3, instead, step 2 may be performed before steps 1 and 3.

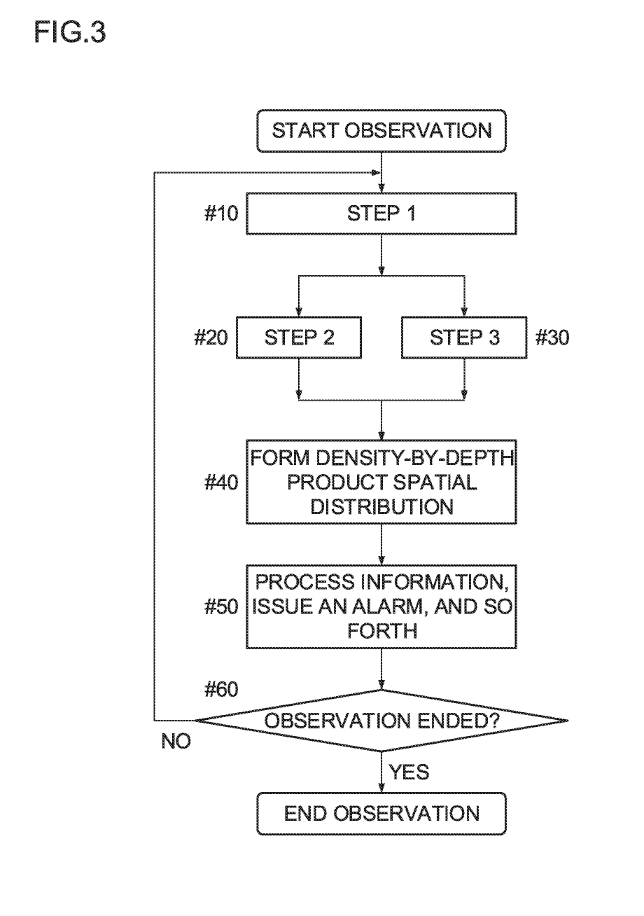

In the observation procedure example 3 (FIG. 3), except that step 2 (#20) and step 3 (#30) are performed simultaneously, the same procedure as in the observation procedure example 1 (FIG. 1) is performed. While, in the observation procedure example 3, step 1 is performed before steps 2 and 3, instead, step 1 may be performed after steps 2 and 3.

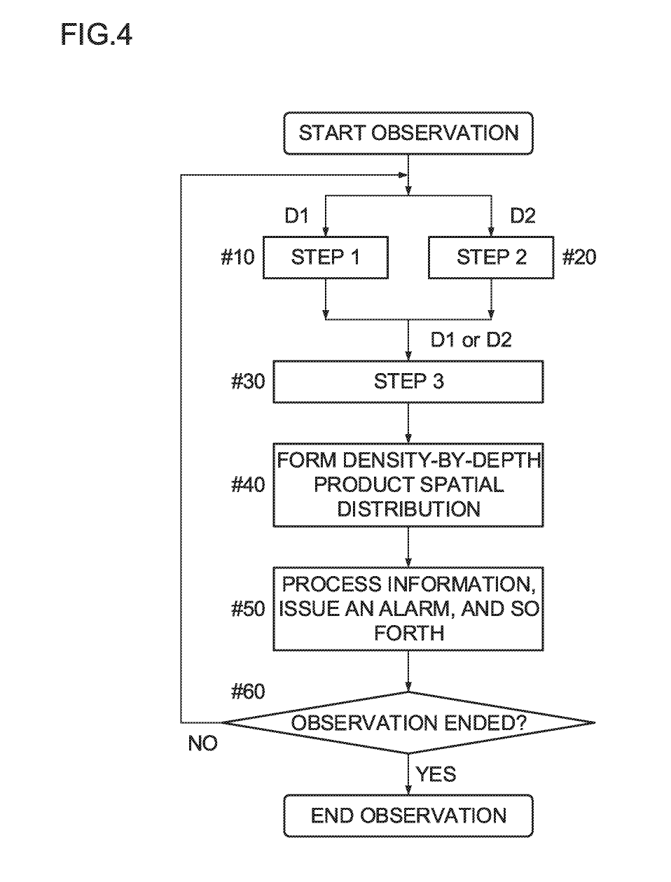

In the observation procedure example 4 (FIG. 4), with two imaging devices D1 and D2 corresponding to the imaging device DU prepared, step 1 (#10) is performed with the imaging device D1, and step 2 (#20) is performed with the imaging device D2. Instead of using two imaging devices D1 and D2, it is possible to use only two lens units LU with the other constituent portions shared. While, in the observation procedure example 4, steps 1 and 2 are performed simultaneously, instead, steps 1 and 2 may be performed in a time sequence; specifically, they may be performed in the order of step 1 then step 2 or in the order of step 2 then step 1. Step 3, which is performed by use of the imaging device D1 or D2, can be performed before steps 1 and 2.

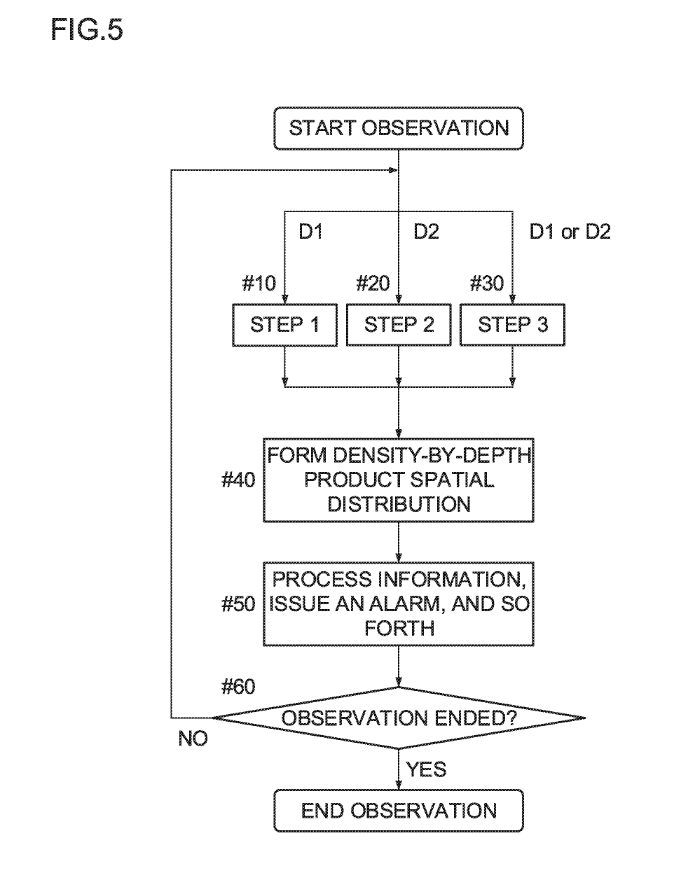

In the observation procedure example 5 (FIG. 5), as in the observation procedure example 4 (FIG. 4), with two imaging devices D1 and D2 corresponding to the imaging device DU prepared, step 1 (#10) is performed with the imaging device D1; step 2 (#20) is performed with the imaging device D2; and step 3 (#30) is performed simultaneously with steps 1 and 2. In addition, step 3 is performed with the imaging device D1 or D2. Here, instead of using two imaging devices D1 and D2, it is possible to use only two lens units LU with the other constituent portions shared.

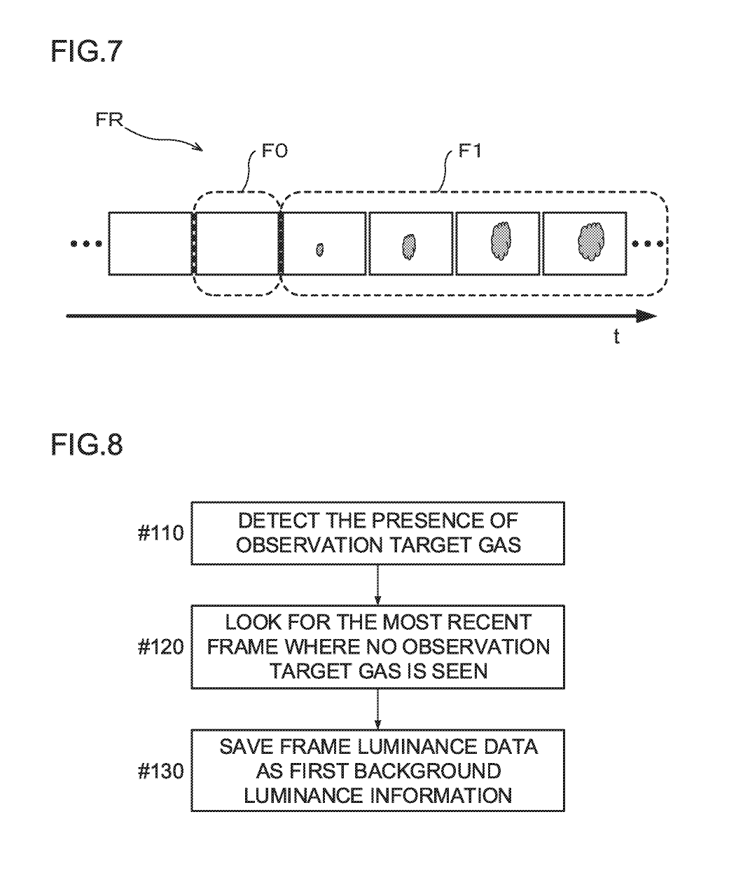

With respect to a specific example 1 of step 1 (#10) in the observation procedure examples 1 to 5, FIG. 7 shows image changes over frames FR (the relationship between frames FR and time t), and FIG. 8 shows control operation (a flow chart of step 1). As a result of the imaging device DU shooting the observation target space and processing the two-dimensional luminance data acquired thereby, if the presence of the observation target gas GS is recognized (#110), from frames F1 in which the presence of the gas is detected, the image data in the frames FR is traced back to look for the most recent frame F0 in which no presence of the observation target gas GS is recognized (that is, no observation target gas GS is seen) (#120). Then, the luminance data of the frame F0 is taken as the electromagnetic-wave luminance of the background HS (the first luminance information) (#130).

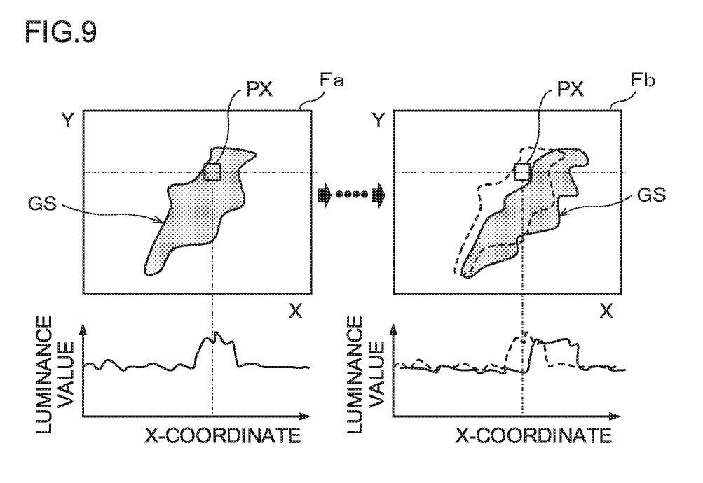

With respect to a specific example 2 of step 1 (#10) in the observation procedure examples 1 to 5, FIG. 9 shows luminance changes from frame Fa to Fb. Here, in each of the frames Fa and Fb in a two-dimensional coordinate system (X, Y), an X section cutting through a pixel of interest PX is represented in terms of luminance value in a graph. The frame Fa is a frame where the observation target gas GS is present at the pixel of interest PX, and the frame Fb is a frame where the observation target gas GS at the pixel of interest PX disappears instantaneously.

In this specific example 2, the observation target space is shot with the imaging device DU; the two-dimensional luminance data acquired by the imaging device DU is processed; and the frame Fa where the observation target gas GS is present is looked for. Then, if the presence of the observation target gas GS is recognized, the frame Fb where the observation target gas GS disappears instantaneously is looked for, with respect to each pixel in the image data, based on luminance changes in the image data between the frames. The luminance data of the frame Fb is taken as the electromagnetic-wave luminance of the background HS for a pixel of interest PX. This is repeated for every pixel, and thereby the luminance data of the frame Fb is taken as the electromagnetic-wave luminance of the background HS (the first luminance information).

FIG. 10 shows the optical filter OF, the imaging device DU, etc. used in a specific example 3 of step 1 (#10) in the observation procedure examples 1 to 5. In front of the imaging device DU, there is retractably inserted the optical filter OF that transmits only electromagnetic waves in a wavelength band that are not absorbed by the observation target gas GS at the risk of leakage. There is also provided an insertion-retraction mechanism 10 for switching the optical filter OF between states inserted in and retracted out of the field of view of the imaging device DU.

When the insertion-retraction mechanism 10 retracts the optical filter OF out of the field of view of the imaging device DU, the optical filter OF moves completely out of the field of view of the imaging device DU; thus, luminance information on an optical image can be acquired without passage through the optical filter OF. On the other hand, when the insertion-retraction mechanism 10 inserts the optical filter OF into the field of view of the imaging device DU, the optical filter OF completely covers the field of view of the imaging device DU; thus, luminance information (fourth luminance information) on an optical image can be acquired through the optical filter OF. An example of the insertion-retraction mechanism 10 is a mechanism that moves the optical filter OF rectilinearly. Another example is a mechanism in which the optical filter OF is arranged on a swing member, and as the swing member is swung, the optical filter OF is moved into and out of the field of view of the imaging device DU.

With the optical filter OF inserted in the field of view of the imaging device DU, the background HS in the observation target space is shot through the optical filter OF, and thereby luminance information on the background HS is acquired. That is, an optical image comprising electromagnetic waves which are radiated from the background HS in a wavelength region within the particular wavelength band excluding a wavelength band absorbed by the observation target gas GS is acquired as the fourth luminance information. The fourth luminance information acquired in the specific example 3 differs in acquired wavelength from the second luminance information acquired at step 2 (#20), and thus the luminance data needs to be corrected. Specifically, correction is performed as follows.

The wavelength range of the optical filter OF transmission wavelength region is represented by λ_{f1} and λ_{f2}, and the transmittance is represented by τ(λ). The wavelength range of the particular wavelength region is represented by λ₁ and λ₂. With respect to the temperature T of the background HS, the function of the black-body radiance luminance is represented by B(T,λ); the luminance acquired by the imaging device DU without passage through the optical filter OF at step 2 (#20) is represented by Iₚ; and the luminance acquired by the imaging device DU through the optical filter OF in the specific example 3 (FIG. 10) of step 1 (#10) is represented by I_{f}.

Correcting the above-described luminance data means multiplying the luminance I_{f} by the correction coefficient k, which is the ratio of the two luminances (Iₚ/I_{f}). Here, the luminances Iₚ and I_{f} are given by formulae (E1) and (E2) below respectively, and thus the correction coefficient k, which is the ratio of the two luminances, is given by formula (E3) below. F(T) and G(T) are both expressed as functions of the background temperature T, and thus, as shown in formula (E4) below, the correction coefficient k can be expressed as a function of the luminance I_{f}. By correcting the luminance I_{f} with the correction coefficient k (correction through multiplication of I_{f} by the correction coefficient k), it is possible to acquire the electromagnetic-wave luminance of the background HS (the first luminance information).

$$\begin{matrix}[ Expression 1 ] & \\ {I}_{p} = {\int }_{{λ}_{1}}^{{λ}_{2}} B ( T , λ ) d λ & ( E 1 ) \\ \begin{matrix}{I}_{f} = {\int }_{{λ}_{f 1}}^{{λ}_{f 2}} τ ( λ ) B ( T , λ ) d λ \\ = F ( T )\end{matrix} & ( E 2 ) \\ k = \frac{{I}_{p}}{{I}_{f}} = \frac{{\int }_{{λ}_{1}}^{{λ}_{2}} B ( T , λ ) d λ}{{\int }_{{λ}_{f 1}}^{{λ}_{f 2}} τ ( λ ) B ( T , λ ) d λ} = G ( T ) & ( E 3 ) \\ k = G ( {F}^{- 1} ( {I}_{f} ) ) & ( E 4 )\end{matrix}$$

At step 2 (#20), the observation target space is shot with the imaging device DU, and thereby an optical image comprising electromagnetic waves which are radiated from the background HS in the particular wavelength band and observed through the observation target gas GS present in the observation target space is acquired as two-dimensional second luminance information.

When electromagnetic waves such as infrared rays radiated from the surface of an object with an intensity commensurate with the absolute temperature there are detected to be visualized, the ambient temperature has a great influence on the change of the object surface temperature as described above, and thus it is necessary to accurately measure ambient temperature information. Thus, at step 3 (#30), by use of luminance information on an optical image acquired by the imaging device DU without passage through the optical member OE and luminance information on an optical image acquired by the imaging device DU through the optical member OE, the imaging device DU calculates the black-body radiance luminance (third luminance information) corresponding to the ambient temperature in or around the observation target space. Here, the temperature of the optical member OE has a great influence on the measurement of the ambient temperature, and thus it is preferable to use the optical member OE in a state acclimated to the ambient temperature. For example, it is preferable to make the temperature of the optical member OE equal to the ambient temperature by waiting for a predetermined time to elapse after the start of the measurement or by waiting for the change of the temperature of the optical member OE over time to fall within a permissible range (close to zero temperature change).

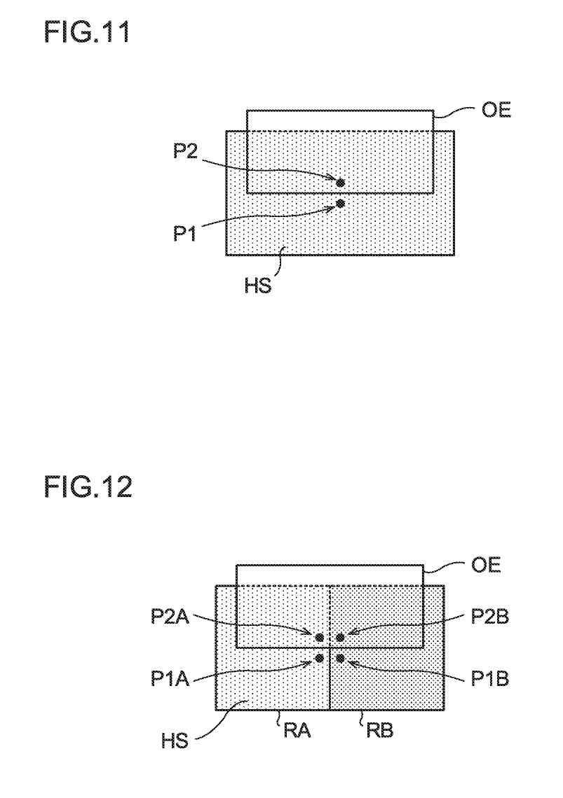

FIG. 11 shows, in a state as seen from the imaging device DU side, the optical member OE used in a specific example 1 of step 3 (#30) and the background HS along with luminance measurement points P1 and P2 on them. The optical member OE has such optical characteristics that the transmittance to electromagnetic waves in the particular wavelength band is higher than 0% but lower than 100% as described above, and is arranged at a place near the observation target space, within the field of view of the imaging device DU so as to cover part of the field of view of the imaging device DU.

Near the circumference of the optical member OE within the field of view of the imaging device DU, there are chosen a measurement point P1 at which the optical member OE does not overlap the background HS and a measurement point P2 at which the optical member OE overlaps the background HS. Here, the luminance value acquired at the measurement point P1 is represented by I₁, the luminance value acquired at the measurement point P2 is represented by I₂, and pieces of luminance information I₁ and I₂ are acquired at the measurement points P1 and P2. The pieces of luminance information used to calculate the black-body radiance luminance are both preferably acquired at measurement points at which the luminance of electromagnetic waves in the particular wavelength band in the background HS is equal; it is thus preferable to set the measurement points P1 and P2 such that they are arranged close to each other.

Let the transmittance of the optical member OE be τ, and let the ambient temperature-equivalent black-body radiance luminance be Iₐᵢᵣ, then (I₁−Iₐᵢᵣ)·τ=I₂−Iₐᵢᵣ holds. Thus, Iₐᵢᵣ−Iₐᵢᵣ·τ=I₂−I₁·τ, and Iₐᵢᵣ (1−τ)=I₂−I₁·τ. Thus, formula (E5) below is obtained.

Iₐᵢᵣ=(I₂−I₁·τ)/(1−τ) (E5)

According to formula (E5) above, the ambient temperature-equivalent black-body radiance luminance Iₐᵢᵣ is calculated.

FIG. 12 shows, in a state as seen from the imaging device DU side, the optical member OE used in a specific example 2 of step 3 (#30) and the background HS along with luminance measurement points P1A, P1B, P2A, and P2B on them. The optical member OE has such optical characteristics that the transmittance to electromagnetic waves in the particular wavelength band is higher than 0% but lower than 100% as described above, and is arranged, so as to cover part of the field of view of the imaging device DU, at a place near the observation target space, within the field of view of the imaging device DU, in front of the background HS having different luminances.

As shown in FIG. 12, the regions having different radiance luminances in the background HS are identified as RA and RB. Near the circumference of the optical member OE within the field of view of the imaging device DU, there are chosen a measurement point P1A within the region RA at which the optical member OE does not overlap the background HS, a measurement point P2A within the region RA at which the optical member OE overlaps the background HS, a measurement point P1B within the region RB at which the optical member OE does not overlap the background HS, and a measurement point P2B within the region RB at which the optical member OE overlaps the background HS. Here, the luminance value acquired at the measurement point P1A is represented by I_{1A}; the luminance value acquired at the measurement point P2A is represented by I_{2A}; the luminance value acquired at the measurement point P1B is represented by I_{1B}; and the luminance value acquired at the measurement point P2B is represented by I_{2B}, and pieces of luminance information I_{1A}, I_{1B}, I_{2A}, and I_{2B} are acquired at the measurement points P1A, P1B, P2A, and P2B. The pieces of luminance information used to calculate the black-body radiance luminance both have only to be acquired at at least two measurement points at which the luminance of electromagnetic waves in the particular wavelength band in the background HS differs. Thus, it is preferable to set the measurement points P1A, P1B, P2A, and P2B such that they are arranged close to each other.

Like formula (E5) above, formula (E6) below is obtained from the relationship among the luminance values.

Iₐᵢᵣ=(I_{1A}·I_{2B}−I_{2A}·I_{1B}){(I_{1A}−I_{2A})−(I_{1B}−I_{2B})} (E6)

According to formula (E6) above, the ambient temperature-equivalent black-body radiance luminance Iₐᵢᵣ is calculated. Here, for each of the regions RA and RB having two different radiance luminances, the optical member OE is either present or absent; thus, the term of the transmittance τ is eliminated with the acquired four-point information.

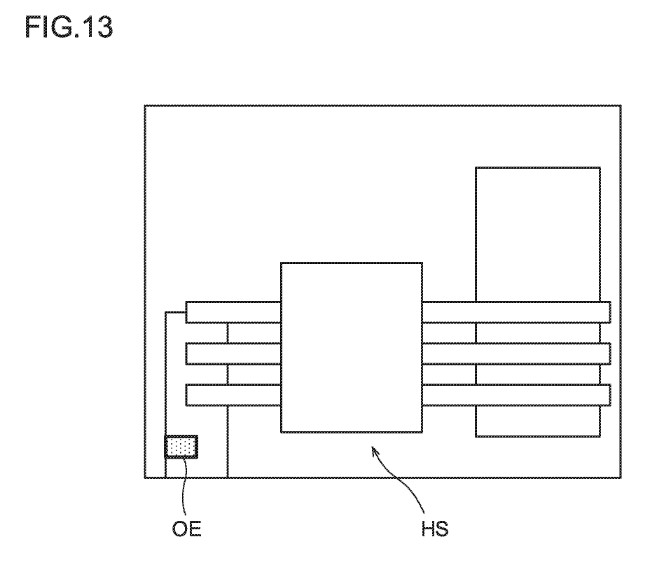

FIGS. 13 to 15 are shot image screens (for example, views of a monitoring target such as a factory or a plant) showing arrangement examples 1 to 3 of the optical member OE used at step 3 (#30). The optical member OE has such optical characteristics that the transmittance to electromagnetic waves in the particular wavelength band is higher than 0% but lower than 100% as described above, and is arranged, so as to cover part of the field of view of the imaging device DU, at a place in or near the observation target space, within the field of view of the imaging device DU.

In the arrangement example 1 (FIG. 13), the optical member OE is so arranged as to be in a corner of the field of view, and thus does not block the observation target space; it is thus possible to measure the luminance information corresponding to the ambient temperature in or around the observation target space. Thus, it is possible to calculate with high accuracy the spatial distribution of the density-by-depth product of the observation target gas GS over the entire region within the field of view of the imaging device DU.

In the arrangement example 1, the optical member OE is arranged below the background HS constituting the observation target space. If the observation target gas GS drifts to the optical member OE, an error may occur in the measurement of the ambient temperature-equivalent black-body radiance luminance. Thus, when the specific gravity of the observation target gas GS of which the possibility of leakage with respect to the air is low, it is preferable, as in the arrangement example 1, to arrange the optical member OE below a place where there is a risk of leakage, On the other hand, when the specific gravity of the observation target gas GS of which the possibility of leakage with respect to the air is high, it is preferable to arrange the optical member OE above the place where there is a risk of leakage. Arranging the optical member OE suitably according to the specific gravity of the observation target gas GS as described above makes the observation target gas GS less likely to drift to the optical member OE. Thus, it is possible to accurately measure the ambient temperature-equivalent black-body radiance luminance, and thus to improve the accuracy of the calculation of the spatial distribution of the density-by-depth product of the gas.

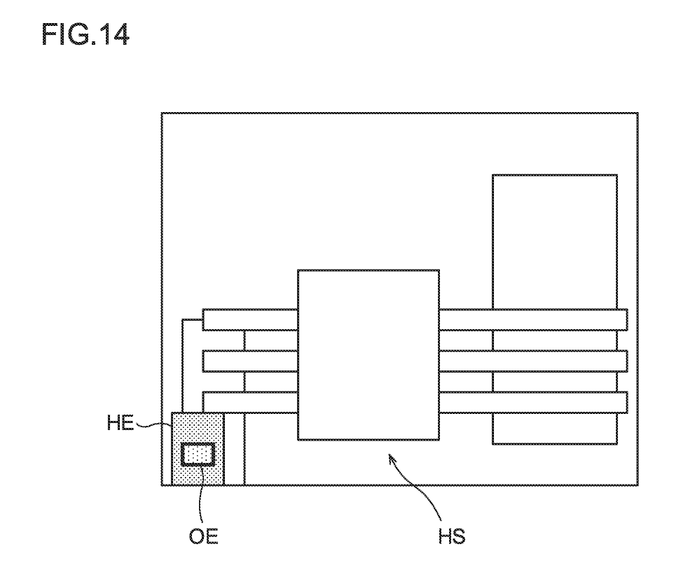

In the arrangement example 2 (FIG. 14), there is arranged behind the optical member OE, as part of the background HS, a background member HE of which the infrared radiance luminance is controlled. As the background member HE, for example, an electromagnetic-wave radiation member is used of which the surface emissivity is substantially 100% (less than 100%) and of which the temperature is controlled. By making use of the properties of the material constituting the background member HE or by applying to the background member HE surface treatment such as by forming surface irregularities or spraying paint (for example, black-body spray), it is possible to adjust the surface emissivity to substantially 100%. Here, as the amount of electromagnetic waves incident from around and reflected increases, the surface emissivity decreases to less than 100%, and when the surface emissivity is 100%, the electromagnetic waves incident from around are not reflected.

Controlling the temperature of the background member HE constituting the background HS (for example, controlling the temperature by use of a Peltier device) helps stabilize the radiance luminance. That is, it is possible to suppress variations over time in the background radiance luminance Thus, using the above-described background member HE permits accurate measurement of the ambient temperature-equivalent black-body radiance luminance; thus, it is possible to improve the accuracy of the calculation of the spatial distribution of the density-by-depth product of the gas. As the background member HE arranged, a member that has at least two regions RA and RB (FIG. 12) having different infrared radiance luminances may be used. For example, when the background HS is formed with a background member HE comprising two or more different electromagnetic-wave radiation members, there is no need to know beforehand the transmittance ti of the optical member OE (formula (E6)); this permits accurate measurement even when the transmittance varies due to secular deterioration or soiling of the optical member OE.

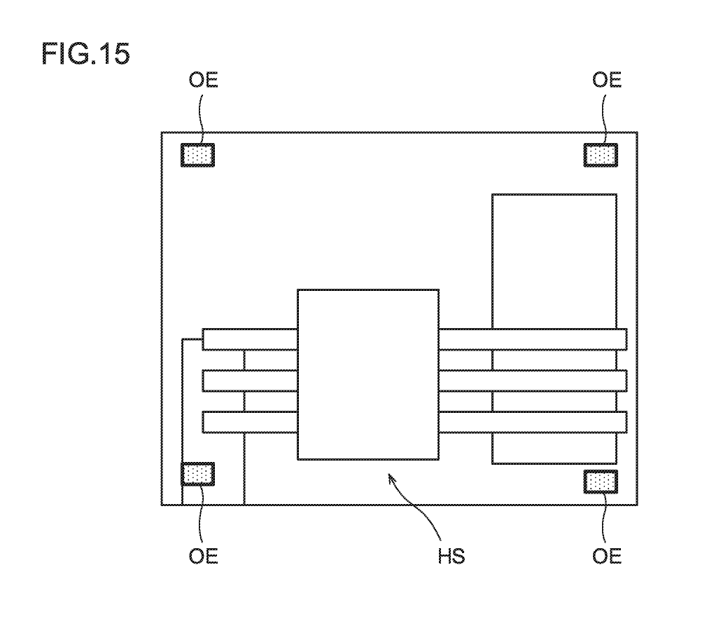

In the arrangement example 3 (FIG. 15), optical members OE are arranged in the four corners of the background HS constituting the observation target space. As described above, if the observation target gas GS drifts to the optical member OE, an error may occur in the measurement of the ambient temperature-equivalent black-body radiance luminance. When the optical members OE are arranged at a plurality of places within the field of view as in the arrangement example 3, the observation target gas GS is less likely to drift to all the optical members OE. Thus, it is possible to accurately measure at at least one place the ambient temperature-equivalent black-body radiance luminance, and thus to improve the accuracy of the calculation of the spatial distribution of the density-by-depth product of the gas.

At step (#40), by use of first to third luminance information acquired as described above, spatial distribution information on the density-by-depth product of the observation target gas GS is acquired. Below, a description will be given of how the density-by-depth product is calculated.

It is supposed that the temperature of leaking gas starts to acclimate to the ambient temperature immediately after leakage and becomes substantially equal to the ambient temperature; thus, the ambient temperature-equivalent black-body radiance luminance Iₐᵢᵣ can be taken as the gas temperature-equivalent black-body radiance electromagnetic-wave luminance Iₐᵢᵣ. Here, according to formula (E7) below, the gas transmittance τ_{gas} is calculated first.

τ_{gas}=1−(I₁ᵢ−I₂ᵢ)/(I₁ᵢ−Iₐᵢᵣ) (E7)

where
τ_{gas} represents the gas transmittance;
I₁ᵢ represents the electromagnetic-wave luminance of the background HS acquired by the imaging device DU at step 1 (first luminance information);
I₂ᵢ represents the electromagnetic-wave luminance acquired by the imaging device DU at step 2 (second luminance information); and
Iₐᵢᵣ represents the ambient temperature-equivalent black-body radiance electromagnetic-wave luminance acquired by the imaging device DU at step 3 (third luminance information).

The gas transmittance τ_{gas} is a function of the density-by-depth product of the gas, and is generally expressed by formula (E8) below. Here, λ₁ and λ₂ represent the wavelength range of the particular wavelength region, α(λ) represents the electromagnetic-wave absorption coefficient of the gas, and ct represents the density-by-depth product.

$$\begin{matrix}[ Expression 2 ] & \\ \begin{matrix}{τ}_{gas} = {\int }_{{λ}_{1}}^{{λ}_{2}} exp ( - α ( λ ) ct ) d λ \\ = f ( ct )\end{matrix} & ( E 8 )\end{matrix}$$

With the inverse function of this function, the density-by-depth product ct can be calculated. If it is difficult to calculate the inverse function, it is preferable to prepare beforehand a correlation table of the density-by-depth product ct and the gas transmittance τ_{gas} to calculate the density-by-depth product ct from the gas transmittance τ_{gas} by interpolation approximation. Then, by calculating the density-by-depth product ct for every pixel in the two-dimensional data acquired by the imaging device DU, it is possible to acquire spatial distribution information on the density-by-depth product ct.

With the above-described gas observation method according to an embodiment, when the presence of the observation target gas GS is detected by use of luminance information from an object surface and ambient temperature information, the ambient temperature information is acquired simultaneously when the observation target space for gas leakage is shot by use of the imaging device DU that acquires as the luminance information an optical image comprising electromagnetic waves in the particular wavelength band; this eliminates the need for a step of converting an output of a thermometer into a luminance. Without use of the thermometer, no errors occur in the ambient temperature information resulting from variations among thermometers or errors in the data conversion step. Thus, it is possible to acquire ambient temperature data as luminance data with high accuracy, and thus to acquire spatial distribution information on the density-by-depth product of the observation target gas GS with high accuracy. Observing and calculating, with the imaging device DU, the observation target space through the optical member OE acclimated to the ambient temperature makes it easier to acquire the ambient temperature data as direct luminance data.

It is only necessary to provide at least an optical member OE, and thus there is no need to provide wires etc. for data transmission; this enhances flexibility in terms of installation place, and helps reduce not only the installation cost but also the maintenance cost for coping with deterioration of and damage to devices. There is no restriction on the place at which to calculate the density-by-depth product; it is thus possible to calculate the spatial distribution of the density-by-depth product at any place within the field of view which is being shot, and thus to easily know how large is the amount of gas leaked in the observation target space.

Although embodiments of the present invention have been described and illustrated in detail, the disclosed embodiments are made for purposes of illustration and example only and not limitation. The scope of the present invention should be interpreted by terms of the appended claims.

### LIST OF REFERENCE SIGNS

DU imaging device
LU lens unit
LN image lens
SR image sensor
OE optical member
OF optical filter
GS observation target gas
HS background
HE background member
AX optical axis
FR, F0, F1, Fa, Fb, frame
PX pixel of interest
P1, P2, P1A, P1B, P2A, P2B measurement point
RA, RB region
1 signal processor
2 calculator-controller
3 memory
4 operation panel
5 display
10 insertion-retraction mechanism

1. A gas observation method for detecting presence of observation target gas in an observation target space by acquiring luminance information on the observation target gas and background thereof with an imaging device that has sensitivity to electromagnetic waves in a particular wavelength band out of electromagnetic waves radiated or reflected from a surface of an object and that acquires as the luminance information an optical image comprising electromagnetic waves in the particular wavelength band, the gas observation method comprising:
acquiring as first luminance information an optical image comprising electromagnetic waves in the particular wavelength band radiated from the background;
acquiring as second luminance information an optical image comprising electromagnetic waves in the particular wavelength band radiated from the background and observed through the observation target gas;
acquiring,
with an optical member arranged between the background and the imaging device, the optical member being able to transmit electromagnetic waves in the particular wavelength band, the optical member having a temperature equal to an ambient temperature,
by use of luminance information on the optical image acquired without passage through the optical member and luminance information on the optical image acquired through the optical member,
as third luminance information an optical image corresponding to the ambient temperature in or around the observation target space and comprising black-body radiation electromagnetic waves in the particular wavelength band; and
acquiring spatial distribution information on a density-by-depth product of the observation target gas by use of the first to third luminance information.

2. The gas observation method of claim 1, wherein:
an optical image comprising electromagnetic waves radiated from the background in a wavelength region within the particular wavelength band excluding a wavelength band absorbed by the observation target gas is acquired as fourth luminance information,
a correction coefficient is calculated from the fourth luminance information,
the fourth luminance information is corrected with the correction coefficient, and thereby
the first luminance information is acquired.

3. The gas observation method of claim 1, wherein pieces of luminance information used to acquire the third luminance information are acquired at at least two measurement points where the luminance of electromagnetic waves in the particular wavelength band in the background is equal or different.
